(19) United States
(12) Patent Application Publication
(10) Pub. No.: US 2026/0034030 A1
(43) Pub. Date: Feb. 5, 2026

(54) ANGLED BABY BOTTLE COLLAR AND NIPPLE

(71) Applicant: Dean O'Neill, Farmington, MI (US)

(72) Inventor: Dean O'Neill, Farmington, MI (US)

(21) Appl. No.: 19/240,422

(22) Filed: Jun. 17, 2025

Related U.S. Application Data
(60) Provisional application No. 63/676,973, filed on Jul. 30, 2024.

(51) Int. Cl. A61J 11/04; A61J 11/02

(52) U.S. Cl. CPC A61J 11/045; A61J 11/02

(57) ABSTRACT

A baby bottle collar for connecting a nipple to a baby bottle including a body having a proximal opening and a distal opening in fluid communication; a nipple retaining protrusion encircling the distal opening, the nipple retaining protrusion configured to engage a nipple of a baby bottle; and a plurality of engagement elements provided adjacent the proximal opening that are configured to engage with an opening of the baby bottle. Where the body of the collar includes an angled bend such that the proximal opening is positioned in non-coaxial alignment with the distal opening. A baby bottle nipple including a nipple body having a proximal opening, a nipple protrusion extending from the nipple body, and a distal opening defined in an end of the nipple protrusion. The nipple protrusion extending from the nipple body at an angle such that a longitudinal axis of the nipple protrusion forms a nonlinear angle.

### RELATED APPLICATIONS

This application claims priority benefit of U.S. Provisional Application Ser. No. 63/676,973, filed 30 Jul. 2024, the contents of which are hereby incorporated by reference.

### FIELD OF THE INVENTION

The present invention in general relates to baby bottles, and an angled collar and/or nipple for attachment to a standard baby bottle that is configured to easily allow liquid contained in the bottle to flow to the nipple without needing to recline the feeding baby to a near horizontal position.

### BACKGROUND OF THE INVENTION

Numerous baby feeding bottles exist, allowing babies to be bottle-fed as a temporary or permanent alternative to breast-feeding. A baby bottle typically has four components: the first is the main container or body of the bottle. A nipple, is the flexible part of the bottle that the baby will suck from, and contains a hole through which the milk will flow. The collar goes over the nipple and typically screws onto the neck of the bottle, forming a seal. Most, but not all baby bottles will also have a cap or travel cover that goes over the nipple to keep it clean and to prevent small spills.

A multitude of options exists in terms of size, shape, and material of each component; Various design characteristics offer options including ease of cleaning, comfort for both caregiver and baby, flow control, and similarity to shape and feel to a natural breast. Some bottles include “anti-colic” features with the goal of reducing gassiness and air intake when feeding. Some bottles try to minimize the mixing of air into the milk within the bottle. At the same time, it is desirable to avoid creating an internal vacuum as the infant sucks out fluids, since this will make it harder to feed. Designs may rely on the bottle's shape or incorporate different types of “venting.”

Even with all the existing options for baby bottles, problems still arise when positioning a baby for feeding from a typical bottle. That is, as the contents of the bottle are consumed and the remaining level within the bottle decreases, a care giver is forced to recline the baby further and further so the bottle can be positioned more and more vertically to allow the liquid to flow into the nipple. This near horizontal positioning of the baby often results in taking in air which can lead to uncomfortable gas, spills, and an increased flow due to gravity acting on the liquid. Often times the increased flow from gravity can cause babies to grow accustomed to speed and ease of feeding from an inverted bottle, creating difficulty for the baby to return to breast-feeding. This can cause a baby to fail to take milk from a woman's breast because of a developed preference for the ease at which liquid flows from the inverted bottle.

Thus, there is a need for a baby bottle that is configured to easily allow liquid contained therein to flow to the nipple without needing to recline the feeding baby to a near horizontal position.

### SUMMARY OF THE INVENTION

The present invention provides a baby bottle collar configured to connect a nipple to a baby bottle. The collar includes a body having a proximal opening and a distal opening, the proximal opening and the distal opening being in fluid communication. The collar also includes a nipple retaining protrusion that encircles the distal opening of the collar body, the nipple retaining protrusion being configured to engage with a nipple of a baby bottle. The collar additionally includes a plurality of engagement elements provided adjacent to the proximal opening of the body of the collar. The plurality of engagement elements are configured to engage with an opening of the baby bottle. Notably, the body of the collar includes an angled bend such that the proximal opening is positioned in non-coaxial alignment with the distal opening.

The present invention additionally provides a baby bottle nipple that includes a nipple body having a proximal opening, a nipple protrusion extending from the nipple body, and a distal opening defined in an end of the nipple protrusion. The nipple protrusion extends from the nipple body at an angle such that a longitudinal axis of the nipple protrusion forms a nonlinear angle.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings wherein:

FIG. 1. is a cross sectional view of an assembled baby bottle according to embodiments of the present invention;

FIG. 2 is an exploded view of a baby bottle according to embodiments of the present invention;

FIG. 3A is a cross-sectional view of a baby bottle collar according to embodiments of the present invention;

FIG. 3B is a cross-sectional view of a baby bottle collar according to embodiments of the present invention;

FIG. 4 shows a baby bottle nipple according to certain embodiments of the present invention;

FIG. 5A is a plan view of a baby bottle nipple according to other embodiments of the present invention; and

FIG. 5B is a front view of the baby bottle nipple depicted in FIG. 5A through line A-A.

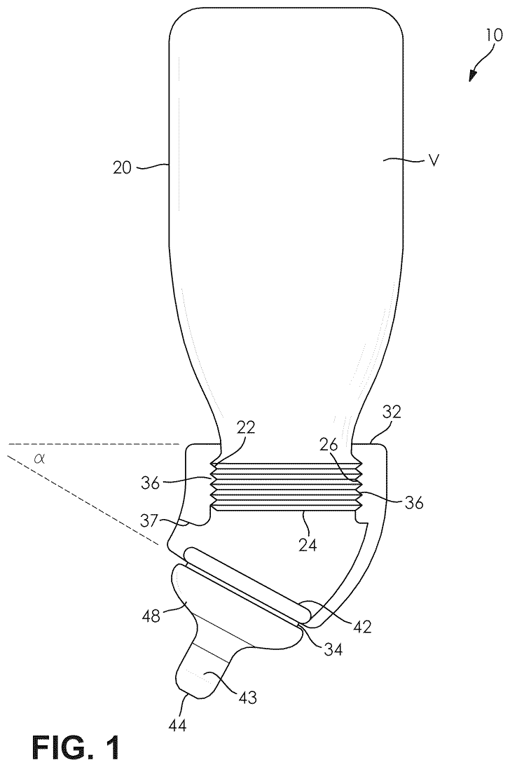

### DESCRIPTION OF THE INVENTION

The present invention has utility as a collar and/or nipple for attachment to a standard baby bottle that is configured to easily allow liquid contained in the bottle to flow to the nipple without needing to recline the feeding baby to a near horizontal position.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

As shown in the figures, embodiments of the invention provide a baby bottle 10 that includes a body 20, a collar 30, and a nipple 40 where at least one of the collar 30 and/or nipple 40, 40′, or 40″includes an angle therein to easily allow liquid contained in the body 20 of the bottle 10 to flow to the nipple 40 40′, or 40″without needing to recline the feeding baby to a near horizontal position. Thus, the inventive bottle 10 allows the feeding baby to be maintained in an upright, nearly vertical position for the duration of the bottle feeding, thereby preventing undesirable air intake and fast, easy flow due to gravity.

According to embodiments, the body 20 of the bottle 10 defines an internal volume V for containing a liquid such as human milk, cow's milk, or formula. The body 20 includes a neck 22 at one end thereof that terminates in a bottle aperture 24 from which the liquid contents of the internal volume V are configured to flow. According to embodiments, the neck 22 includes threads 26 on an external surface thereof. According to embodiments, the body 20 is formed of a food grade material, such as glass, stainless steel, plastic, or silicone. According to embodiments, the body 20 is transparent to allow the contents contained in the internal volume V to be visible from the outside of the body 20. According to embodiments, the body 20 includes markings for indicating a level or volume of the liquid contained within the internal volume V of the body 20. According to embodiments, the body 20 of the bottle 10 is a standard container body of a baby bottle that is available in the marketplace.

According to embodiments, the collar 30 includes a proximal opening 32 and a distal opening 34, with the proximal opening 32 being in fluid communication with the distal opening 34. According to embodiments, the proximal opening 32 includes a plurality of engagement elements 36, 36′, 36″ positioned on an interior surface of the collar 30 that are configured to engage with the threads 26 on the neck 22 of the body 20. According to embodiments, the plurality of engagement elements 36, 36′, 36″ are configured to engage with a wide variety of thread types so as to ensure compatibility with a wide variety of existing baby bottle bodies 20 that may have different thread types. Accordingly, the plurality of engagement elements are threads 36, discontinuous channels 36′, or clips 36″ that snap or thread onto the threads 26 of the neck 22 of the body 20 to ensure a secure engagement therewith. The distal opening 34 is configured to engage with and retain the nipple 40 and according to embodiments includes a nipple retaining 38 protrusion that encircles the distal opening 34 of the collar 30. According to embodiments, the collar 30 includes an angled bend 37 therein such that the proximal opening 32 in non-coaxial alignment with the distal opening 34. According to embodiments, the distal opening 34 is positioned approximately 10-90 degrees, most preferably approximately 45 degrees, out of coaxial alignment with the proximal opening 32, to enable the baby to be held upright while feeding from the baby bottle 10. In other words, the planes in which the proximal opening 32 and the distal opening 34 lie form an angle α that is between 10 and 90 degrees, most preferably approximately 45 degrees. According to embodiments, the collar 30 is preferably constructed of food grade molded plastic. When assembled with the body 20 and the nipple 40, the proximal opening 32 of the collar 30 communicates with the distal opening 34 of the collar 30 so that liquid from the internal volume V of the body 20 is transmitted to the nipple 40 through the collar 30.

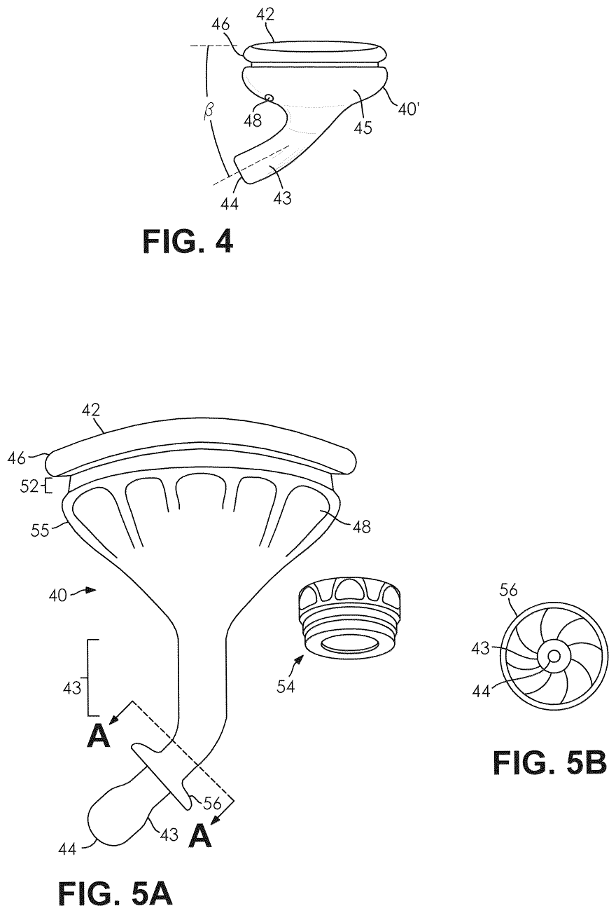

According to certain inventive embodiments, depicted in FIG. 4 the nipple 40′ includes a proximal opening 42 and a distal opening 44, with the proximal opening 42 being in fluid communication with the distal opening 44. According to embodiments, the nipple 40 includes a nipple flange 46 that encircles the proximal opening 42. According to embodiments, the nipple flange 46 sealably engages with the nipple retaining protrusion 38 that encircles the distal opening 34 of the collar 30. According to embodiments, the distal opening 44 of the nipple 40′ is provided in a tip of a nipple protrusion 43, the nipple protrusion 43 being the portion of the nipple 40′ that is configured to a baby to latch with and drink from. According to embodiments, the distal opening 44 is provided in a variety of different sizes so as to allow for various flow rates. According to embodiments, the nipple is formed of food grade silicone material. According to embodiments, the nipple 40 includes a vent hole 48 that allows air to flow into the internal volume V of the body 20 of the bottle 10 so as to prevent a vacuum from forming in the bottle 10 as liquid is removed. According to embodiments, the nipple 40′ is a standard nipple provided off the shelf in the marketplace. According to embodiments, the nipple protrusion 43 is positioned in the center of the nipple body 45, while according to other embodiments, the nipple protrusion 43 is provided off center of the nipple body 45. According to embodiments, the nipple protrusion 43 extends from the nipple body 45 such that the nipple protrusion 43 is perpendicular to the plane in which the proximal opening 42 lies, while according to other embodiments, the nipple protrusion 43 extends from the nipple body 45 at an angle such that the longitudinal axis of the nipple protrusion 43 forms an angle β with the plane in which the proximal opening 42 lies, the angle β being less than 90 degrees.

Advantageously, the collar 30 and the nipple 40, 40′, or 40″, alone or in combination, are configured to be used with a wide variety of standard, off the shelf baby bottle components, thereby allowing a caregiver to modify the angle at which an already purchased, off the shelf baby bottle system is provided to a baby. The present invention provides a bottle 10 and components thereof that is configured to easily allow liquid contained in the bottle to flow to the nipple without needing to recline the feeding baby to a near horizontal position. Instead, the inventive bottle 10 allows the feeding baby to be maintained in an upright, nearly vertical position for the duration of the bottle feeding, thereby preventing undesirable air intake and fast, easy flow due to gravity.

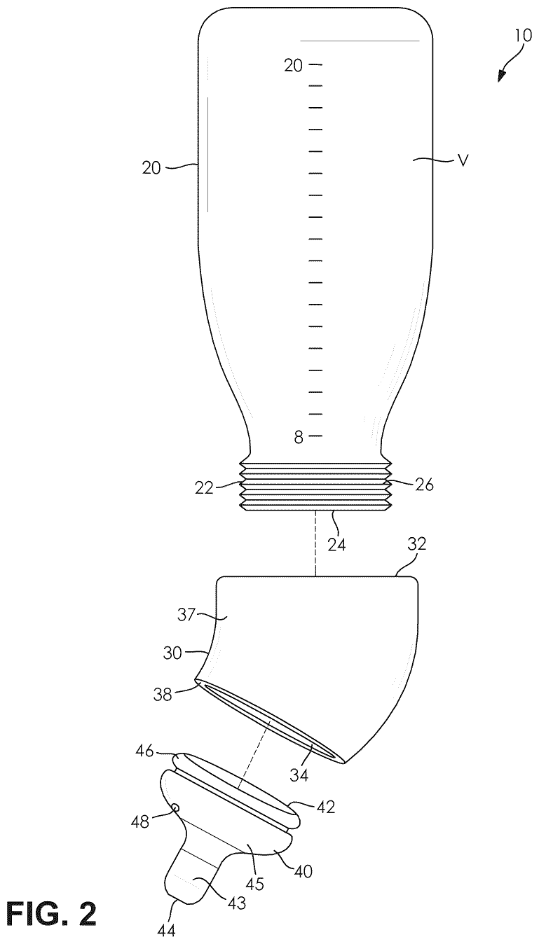

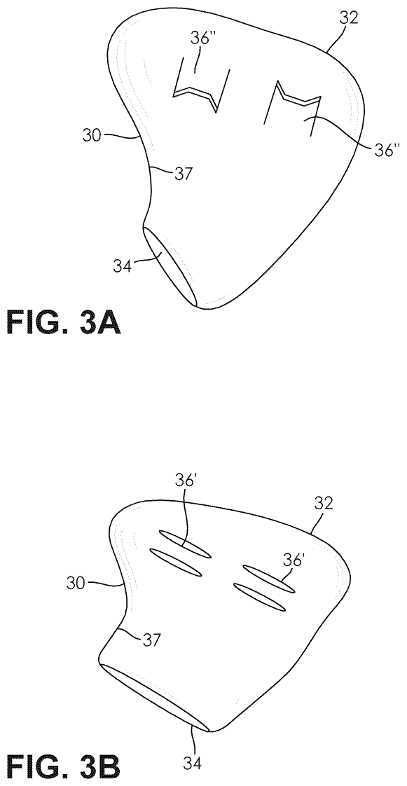

Another inventive embodiment is depicted in FIGS. 5A and 5B, in which like numerals have the meanings ascribed thereto with respect to the aforementioned drawings. A nipple 40″ includes a proximal opening 42 and a distal opening 44, with the proximal opening 42 being in fluid communication with the distal opening 44. The nipple 40″ includes a nipple flange 46 that encircles the proximal opening 42. According to certain inventive embodiments, the nipple flange 46 is contiguous to a groove 52, the flange 46 sealably engages with bottle aperture 24 of the body of a bottle 20, as shown in FIG. 2 with resort to a conventional collar 54 that is depicted not to scale for visual clarity and engages the threads around the bottle aperture 24 to retain the nipple 40″ in a fluid tight seal with the bottle body 20. The groove 52 transitions to a funnel portion 55 that tapers from approximately the diameter of the bottle aperture 24 to approximately that of nipple protrusion 43. The distal opening 44 of the nipple 40″ is provided in a tip of a nipple protrusion 43, the nipple protrusion 43 being the portion of the nipple 40″ that is configured to a baby to latch with and drink therefrom. The nipple protrusion 43 terminates in a guard 56 to provide a surface against which a baby's lips can rest. An angled neck portion 58 joins the guard 56 to the funnel portion 58. In some embodiments of the present invention, as best shown in FIG. 5B, a distal face 60 of the guard 56 is textured, while in other embodiments, the texture includes a curved line pattern. The nipple 40″ is formed of same materials as detailed above with respect to 40 or 40′. According to some inventive embodiments, the nipple 40″ includes a vent hole 48 that allows air to flow into the internal volume V of the body 20 of the bottle 10 so as to prevent a vacuum from forming therein as liquid is removed. The neck portion 58 is shown with an angle the nipple protrusion 43 of 120 degrees. In other inventive embodiments, this angle is between 105 and 170 degrees.

A conventional bottle 10 mounting a nipple 40″ allows the feeding baby to be maintained in an upright, nearly vertical position for the duration of the bottle feeding, thereby preventing undesirable air intake and fast, easy flow due to gravity.

As a person skilled in the art will recognize from the previous detailed description and from the figures and claims, modifications and changes can be made to the preferred embodiments of the invention without departing from the scope of this invention defined in the following claims.

1. A baby bottle collar configured to connect a nipple to a baby bottle, the collar comprising:
a body having a proximal opening and a distal opening, the proximal opening and the distal opening being in fluid communication;
a nipple retaining protrusion that encircles the distal opening of the collar body, the nipple retaining protrusion configured to engage with a nipple of a baby bottle; and
a plurality of engagement elements provided adjacent to the proximal opening of the body of the collar, the plurality of engagement elements configured to engage with an opening of the baby bottle;
wherein the body of the collar includes an angled bend such that the proximal opening is positioned in non-coaxial alignment with the distal opening.

2. The collar of claim 1 wherein the body is formed of food grade molded plastic.

3. The collar of claim 1 wherein the body, the nipple retaining protrusion, and the plurality of engagement elements are integrally formed.

4. The collar of claim 1 wherein the plurality of engagement elements are provided on an internal surface of the body of the collar.

5. The collar of claim 1 wherein the plurality of engagement elements are configured to sealably engage with the opening of the baby bottle.

6. The collar of claim 1 wherein the plurality of engagement elements are configured to engage with threads on the opening of the baby bottle.

7. The collar of claim 1 wherein the plurality of engagement elements are threads.

8. The collar of claim 1 wherein the plurality of engagement elements are discontinuous channels.

9. The collar of claim 1 wherein the plurality of engagement elements are clips.

10. The collar of claim 1 wherein the angled bend is 10 to 90 degrees.

11. A baby bottle nipple comprising:
a nipple body having a proximal opening;
a nipple protrusion extending from the nipple body; and
a distal opening defined in an end of the nipple protrusion;
wherein the nipple protrusion extends from the nipple body at an angle such that a longitudinal axis of the nipple protrusion forms a nonlinear angle.

12. The nipple of claim 11 further comprising a vent hole formed in the nipple body.

13. The nipple of claim 11 wherein the nipple protrusion is provided in a center of the nipple body.

14. The nipple of claim 11 wherein the nipple protrusion is provided in an off-center position on the nipple body.

15. The nipple of claim 11 further comprising a nipple flange that is configured to engage with a baby bottle collar.

16. The nipple of claim 11 wherein the nipple is formed of a food grade silicone material.

17. The nipple of claim 11 wherein the angle is present in a neck portion intermediate between the nipple body and the nipple protrusion.
